(19) United States
(12) Patent Application Publication
(10) Pub. No.: US 2015/0374082 A1
(43) Pub. Date: Dec. 31, 2015

(54) CANE BASE

(71) Applicant: Alltech Design, LLC, Euclid, OH (US)

(72) Inventors: Gary Austin, Euclid, OH (US); Tim Austin, Mentor, OH (US)

(21) Appl. No.: 14/750,690

(22) Filed: Jun. 25, 2015

Related U.S. Application Data
(60) Provisional application No. 62/017,036, filed on Jun. 25, 2014.

(51) Int. Cl. A45B 9/04; B29C 37/00

(52) U.S. Cl. CPC A45B 9/04; B29C 37/0053; B29K 2021/00

(57) ABSTRACT

A base for a cane, walking stick, or the like has a center portion and legs. The center portion has a bore through which a shaft of the cane can be inserted. The bore may have a metal stopper at its base. A bellows is around the outside of the center portion, and is tapered toward the top of the center portion. The legs have winglets extending from opposite sides. The center portion and legs may be manufactured of a first material, while the bellows and winglets are manufactured of a second material. During manufacturing, the bellows and winglets may be overmolded the center portion and legs. The bellows and winglets may be connected through a channel in each leg.

### BACKGROUND OF THE INVENTION

Canes, walking sticks, and the like are commonly used by individuals with various degrees of walking disabilities as a way of providing support and/or stability while walking Often, canes have small tips with a minimal surface area to contact the ground. As a result, if the individual places any weight on the cane, the cane and individual can become unstable. Larger cane bases can provide a greater surface area for contacting the ground, however, such canes are inflexible. That is, like small tips, larger cane bases require the individual to place the cane perpendicular to the ground, or when shifting weight to the cane, exerting a force perpendicular to the ground. As individuals often place their weight on the cane at an angle (e.g., leaning from the side or placing it in front of their gait), even canes with larger bases can be unstable. Because a purpose of a cane is to increase an individual's support and/or stability while walking, canes with such bases fail to address the needs of the individuals that use them.

### BRIEF SUMMARY OF THE INVENTION

According to one example described herein, an end for a walking aid comprises a center portion comprising a bore and a bellows; and at least one leg comprising winglets extending beyond opposites sides of the at least one leg, wherein the center portion and legs are made of a first material and the bellows and the winglets are made of a second material.

In various embodiments of the above example, a portion of one of the winglets extending beyond one of the sides of the leg extends upward along the one of the sides of the leg; the first material has a 75 Shore A durometer hardness and the second material has a 55 Shore A durometer hardness; the end further comprises a metal stopper at a base of the bore; the bellows is tapered toward a top of the center portion; and/or the bellows is connected to the winglets through a channel in the leg.

According to another example described herein, an end for a walking aid comprises a center portion comprising a bore and a bellows; and a plurality of legs, each leg comprising at least one winglet extending beyond a side of the leg, wherein the center portion and the legs are made of a first material and the bellows and the winglets are made of a second material.

In various embodiments of the above example, the plurality of legs extend outwardly from the center portion at equal angles; the plurality of legs have an equal length from a center of the bore to a tip of the leg; a portion of the winglet extending beyond the side of the leg extends upward along the side of the leg; the first material has a 75 Shore A durometer hardness and the second material has a 55 Shore A durometer hardness; the end further comprises a metal stopper at a base of the bore; the bellows is tapered toward a top of the center portion; the bellows is connected to the at least one winglet through a channel in each of the plurality of legs; and/or the plurality of legs comprises three legs.

According to still another example described herein, a method for manufacturing an end for a walking aid comprises molding a center portion and at least one leg from a first material, the center portion comprising a bore and each of the at least one legs comprising a channel from a top of the leg to a bottom of the leg; and molding a bellows around the outside of the center portion and a foot underneath each leg from a second material, the foot extending beyond a side of the leg to form a winglet, wherein the second material is overmolded on the first material and the bellows is connected to the foot of each of the at least one legs via the channel.

In various embodiments of the above example, a portion of the winglet extending beyond the side of the leg extends upward along the side of the leg; the first material has a 75 Shore A durometer hardness and the second material has a 55 Shore A durometer hardness; the method further comprises inserting a metal stopper at a base of the bore; and/or the bellows is tapered toward a top of the center portion.

### BRIEF DESCRIPTION OF THE DRAWINGS

FIG. 1 illustrates a perspective view of a cane base described herein attached to a cane;

FIG. 2 illustrates a perspective view of a cane base;

FIG. 3 illustrates a top view of a cane base;

FIG. 4 illustrates a cross-section of a cane base;

FIG. 5 illustrates a side view of a cane base;

FIG. 6 illustrates a bottom view of a cane base; and

FIG. 7 illustrates another perspective view of a cane base.

### DETAILED DESCRIPTION OF THE DRAWINGS

The present disclosure relates to an end (e.g., base, tip, or the like) for a walking aid (e.g., a cane, walking stick, or the like). While the following disclosure is related to a base for a cane, it is to be understood that such an application is merely used for descriptive purposes and that the disclosure should not be limited to such an embodiment.

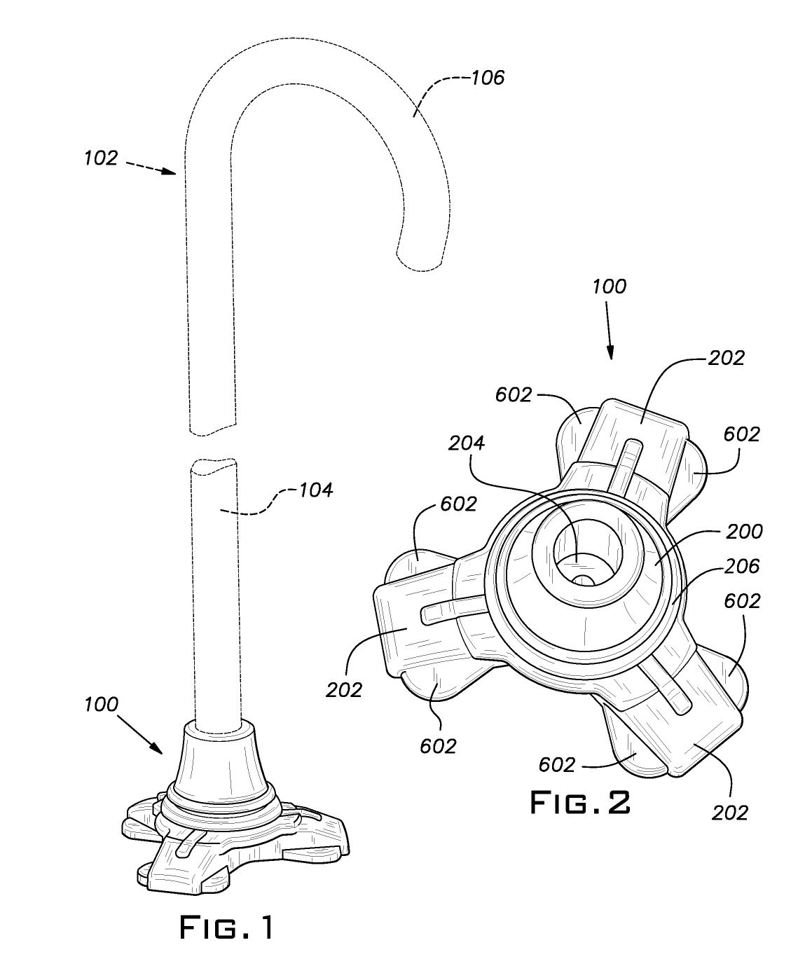

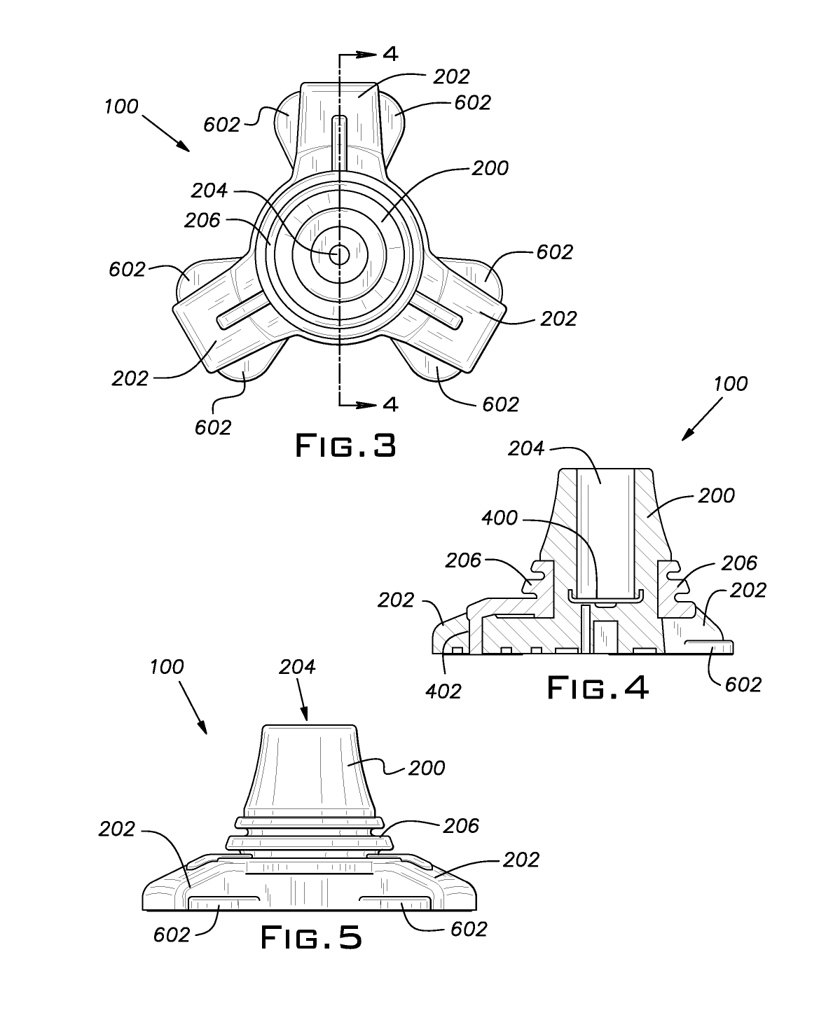

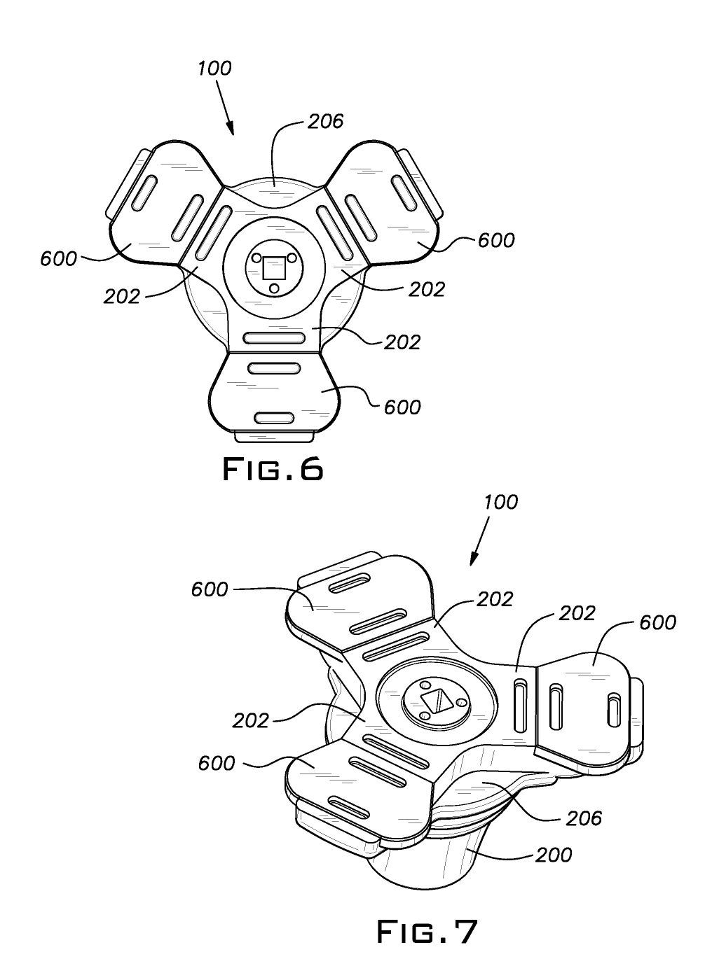

FIG. 1 illustrates a perspective view of an embodiment of a cane base 100 described herein attached to a cane 102. FIG. 2 illustrates a perspective view of the cane base 100 alone. As shown in FIG. 1, the cane 102 has a shaft 104 and a curved handle portion 106, the cane base 100 being attached to the end of the shaft 104 opposite the handle portion 106. It is to be noted that the cane base 100 is independent of the particular cane and that the cane shown in FIG. 1 is not intended to represent a limiting embodiment. Thus, the cane base 100 may be used with any cane, including walking sticks and the like, as desired by a user.

As shown in each of the figures, the cane base 100 includes a center portion 200 and legs 202 extending radially outward from the center portion 200. The center portion 200 includes a bore 204 for holding a shaft of a cane. The inner diameter of the bore 204 may be slightly smaller than the outer diameter of the shaft of the cane so as to facilitate a tight fit. In addition to, or in the alternative, other fitting mechanisms are envisioned for fitting a cane shaft to the cane base 100. Such mechanisms include lining the bore 204 and/or the shaft of the cane with an adhesive, bolting the shaft through the center portion 200 or bore 204, and the like. A metal plate 400, washer, or the like, may be placed at the bottom of the bore 204 so as to prevent a cane shaft from penetrating through the center portion 200 of the cane base 100. The center portion 200 also includes a bellows-like structure 206 (referred to hereinafter as a “bellows”) around the outside of the center portion 200. The bellows-like structure 206 may be tapered toward the top of the cane base 100. The bellows 206 provide flexibility and support to the center portion 200 so that the center portion 200 may bend and rotate if a user holds a cane at an angle with respect to the cane base 100.

As mentioned above, the cane base 100 includes legs 202 extending radially outward from the center portion 200. Although three legs 202 are shown in the figures, a different number of legs may be included in various embodiments and the illustration of three legs is not intended to be limiting. The legs 202 are shown as having the same length from the center of the bore 204 to the tip of the leg and extending from the center portion 200 at equal angles, thereby creating a symmetrical cane base 100. As shown in FIGS. 4 and 5, the height of the legs 202 is greater at locations proximal to the center portion 200 of the cane base 100 and is smaller near a flat tip of the leg 200. Again, these illustrated physical features are not intended to be limiting. Thus, the legs 202 may have different lengths, extend from the center portion 200 at different angles, have a constant or variable height, and/or have sharp tips. These features may vary relative to each leg, and/or each embodiment.

Additionally, each leg 202 comprises a foot 600 underneath the leg 202 that extends beyond the width of the leg 202 on at least one side, thereby creating winglets 602. Each winglet can also extend upward along the side of each leg 202. While the illustrated winglets 602 are rounded, it is also envisioned that the winglets 602 could be squared or have any other shape. The surface of the bottom of the leg 202, foot 600, and center portion 200, may also contain grooves, contours, rough spots, and the like in order to increase grip.

The cane base 100, including the center portion 200, legs 202, and feet 600, may be manufactured from multiple materials, for example, using an overmolding process. Such manufacturing may occur in a single-step overmolding process, or multi-step overmolding process (e.g., a first step for a first material and a second step for a second material). When manufactured using two materials, a first material is used to mold the center portion 200 and legs 202. A second material may then be overmolded to form the bellows 206 around the center portion 200 and the feet 600 including winglets 602. A channel 402 in each leg 202 allows the second material to be continuously connected to the feet 600 and winglets 602. This channel 402 also strengthens the mechanical and chemical connections between the first and second materials. The use of a harder material for the center portion 200 and legs 202 provides structural integrity and support to the cane base 100. The addition of a softer material for the bellows 206 and winglets 602 gives the cane base 100 a flexibility that otherwise would not exist with a single harder material.

Therefore, manufacturing the cane base 100 from two or more materials allows the cane base 100 to remain structurally supportive while also being flexible during use. The first material can be a plastic or rubber that is relatively harder than the second material. For example, the first material may have a 75 Shore A durometer hardness and the second material may have a 55 Shore A durometer hardness. In other embodiments, the first material may have a 68-82 Shore A hardness and the second material may have a 45-62 Shore A hardness. The cane base 100, including the center portion 200, legs 202, and feet 600, may also be manufactured from a single material or more than two materials.

It should be evident that this disclosure is by way of example and that various changes may be made by adding, modifying or eliminating details without departing from the fair scope of the teaching contained in this disclosure. The invention is therefore not limited to particular details of this disclosure.

What is claimed is:

1. An end for a walking aid, the end comprising:
a center portion comprising a bore and a bellows; and
at least one leg comprising winglets extending beyond opposites sides of the at least one leg,
wherein the center portion and legs are made of a first material and the bellows and the winglets are made of a second material.

2. The end of claim 1, wherein a portion of one of the winglets extending beyond one of the sides of the leg extends upward along the one of the sides of the leg.

3. The end of claim 1, wherein the first material has a 75 Shore A durometer hardness and the second material has a 55 Shore A durometer hardness.

4. The end of claim 1, further comprising a metal stopper at a base of the bore.

5. The end of claim 1, wherein the bellows is tapered toward a top of the center portion.

6. The end of claim 1, wherein the bellows is connected to the winglets through a channel in the leg.

7. An end for a walking aid, the end comprising:
a center portion comprising a bore and a bellows; and
a plurality of legs, each leg comprising at least one winglet extending beyond a side of the leg,
wherein the center portion and the legs are made of a first material and the bellows and the winglets are made of a second material.

8. The end of claim 7, wherein the plurality legs extend outwardly from the center portion at equal angles.

9. The end of claim 7, wherein the plurality legs have an equal length from a center of the bore to a tip of the leg.

10. The end of claim 7, wherein a portion of the winglet extending beyond the side of the leg extends upward along the side of the leg.

11. The end of claim 7, wherein the first material has a 75 Shore A durometer hardness and the second material has a 55 Shore A durometer hardness.

12. The end of claim 7, further comprising a metal stopper at a base of the bore.

13. The end of claim 7, wherein the bellows is tapered toward a top of the center portion.

14. The end of claim 7, wherein the bellows is connected to the at least one winglet through a channel in each of the plurality of legs.

15. The end of claim 7, the plurality of legs comprising three legs.

16. A method for manufacturing an end for a walking aid, comprising:
molding a center portion and at least one leg from a first material, the center portion comprising a bore and each of the at least one legs comprising a channel from a top of the leg to a bottom of the leg; and
molding a bellows around the outside of the center portion and a foot underneath each leg from a second material, the foot extending beyond a side of the leg to form a winglet,
wherein the second material is overmolded on the first material and the bellows is connected to the foot of each of the at least one legs via the channel.

17. The method of claim 16, wherein a portion of the winglet extending beyond the side of the leg extends upward along the side of the leg.

18. The method of claim 16, wherein the first material has a 75 Shore A durometer hardness and the second material has a 55 Shore A durometer hardness.

19. The method of claim 16, further comprising inserting a metal stopper at a base of the bore.

20. The method of claim 16, wherein the bellows is tapered toward a top of the center portion.
